(19) United States
(12) Patent Application Publication
(10) Pub. No.: US 2014/0022693 A1
(43) Pub. Date: Jan. 23, 2014

(54) CERAMIC ELECTRONIC COMPONENT AND METHOD OF MANUFACTURING THE SAME

(71) Applicant: SAMSUNG ELECTRO-MECHANICS CO., LTD., Suwon (KR)

(72) Inventors: Kyu Ree KIM, Suwon (KR); Hyun Tae KIM, Suwon (KR); Jong Woo CHOI, Suwon (KR); Sang Hoon KWON, Suwon (KR); Dae Bok OH, Suwon (KR)

(73) Assignee: SAMSUNG ELECTRO-MECHANICS CO., LTD., Suwon (KR)

(21) Appl. No.: 13/887,261

(22) Filed: May 3, 2013

(30) Foreign Application Priority Data
Jul. 23, 2012 (KR) 10-2012-0079900

(51) Int. Cl. H01G 4/30

(52) U.S. Cl. CPC H01G 4/30
USPC 361/301.4; 427/79

(57) ABSTRACT

There is provided a ceramic electronic component, including: a ceramic body including a plurality of internal electrodes; a first external electrode layer electrically connected to the internal electrodes and formed on external surfaces of the ceramic body; a second external electrode layer including nickel (Ni), formed on the first external electrode layer; a metal coating layer including tin (Sn), formed on external surfaces of the first external electrode layer and the second external electrode layer; and a diffusion layer formed between the first and second external electrode layers and the metal coating layer.

### CROSS-REFERENCE TO RELATED APPLICATIONS

This application claims the priority of Korean Patent Application No. 10-2012-0079900 filed on Jul. 23, 2012, in the Korean Intellectual Property Office, the disclosure of which is incorporated herein by reference.

### BACKGROUND OF THE INVENTION

1. Field of the Invention

The present invention relates to a ceramic electronic component having excellent reliability and a method of manufacturing the same.

2. Description of the Related Art

Generally, electronic components using a ceramic material, such as a capacitor, an inductor, a piezoelectric element, a varistor, a thermistor, or the like, include a ceramic body formed of a ceramic material, internal electrodes formed within the ceramic body, and external electrodes mounted on surfaces of the ceramic body so as to be connected to the internal electrodes.

Among ceramic electronic components, a multi-layered ceramic capacitor is configured to include a plurality of stacked dielectric layers, internal electrodes disposed to face each other, having the dielectric layer interposed therebetween, and external electrodes electrically connected to the internal electrodes.

The multi-layered ceramic capacitor can be miniaturized while securing high capacity, and be easily mounted, and therefore has been widely used as a component in computers as well as in mobile communications devices, such as PDAs, mobile phones, and the like.

As demand for small and multi-functional electronic products has increased, chip components have also tended to be miniaturized and multi-functional. Therefore, demand for small, large-capacity multi-layered ceramic capacitors has correspondingly increased.

Therefore, attempts to implement miniaturization and large capacity in multi-layered ceramic capacitors have been conducted by maintaining overall chip size to be the same while reducing a thickness of the external electrode layers.

Meanwhile, when the multi-layered ceramic capacitor is mounted on a substrate, nickel/tin (Ni/Sn) plating is performed on the external electrode layers so as to facilitate the mounting thereof.

The plating process is generally performed by an electrical deposition or electrolytic plating method. In this case, however, the reliability of the multi-layered ceramic capacitor may be degraded due to a plating solution permeated thereinto or hydrogen gas generated at the time of plating.

In order to solve the above defects, a method of directly applying melted solder paste to the external electrode layers has been devised.

A melting temperature of tin (Sn) is about 230° C. to 265° C. When an electrode layer including copper (Cu) is dipped in a solder paste including tin (Sn) at the melting temperature, an intermetallic compound (IMC) layer such as Cu₆Sn₅, and the like, may be formed between the copper (Cu) electrode layer and the tin (Sn) layer.

In this case, when thermal characteristics, electrical characteristics, and the like, are applied to the IMC layer, the IMC layer is grown towards an electrode layer or a tin (Sn) layer to encroach on the electrode layer or the tin (Sn) layer.

In addition, the grown IMC layer may cause fatal defects related to electrical characteristics, reliability, reflow, and the like.

Therefore, there is a need to introduce a ceramic electronic component capable of significantly reducing the formation of an IMC layer and a method of manufacturing the same.

### RELATED ART DOCUMENT

Japanese Patent Laid-Open Publication No. 2011-054642

### SUMMARY OF THE INVENTION

An aspect of the present invention provides a method of manufacturing a ceramic electronic component, in which a metal layer is formed by applying a solder paste thereto.

Another aspect of the present invention provides a ceramic electronic component capable of significantly reducing an IMC layer formed between an electrode layer and a metal coating layer and a method of manufacturing the same.

Another aspect of the present invention provides a ceramic electronic component having a diversified solder paste composition and a method of manufacturing the same.

According to an aspect of the present invention, there is provided a ceramic electronic component, including: a ceramic body including a plurality of internal electrodes; a first external electrode layer electrically connected to the internal electrodes and formed on external surfaces of the ceramic body; a second external electrode layer including nickel (Ni), formed on the first external electrode layer; a metal coating layer including tin (Sn), formed on external surfaces of the first external electrode layer and the second external electrode layer; and a diffusion layer formed between the first and second external electrode layers and the metal coating layer.

The first external electrode layer and the second external electrode layer may include copper (Cu).

The metal coating layer may include at least one of a Sn—Ag—Cu alloy, a Sn—Ag—Cu—Ni alloy, and a Sn—Ag—Cu—Ni—Ge alloy.

The diffusion layer may include a copper (Cu)—tin (Sn) alloy.

According to another aspect of the present invention, there is provided a ceramic electronic component, including: a ceramic body including a plurality of internal electrodes; external electrode layers electrically connected to the internal electrodes, including nickel (Ni), and formed on external surfaces of the ceramic body; a metal coating layer including tin (Sn), formed on external surfaces of the external electrode layers; and a diffusion layer formed between the external electrode layer and the metal coating layer.

The metal coating layer may include at least one of a Sn—Ag—Cu alloy, a Sn—Ag—Cu—Ni alloy, and a Sn—Ag—Cu—Ni—Ge alloy.

The diffusion layer may include a copper (Cu)—tin (Sn) alloy.

According to another aspect of the present invention, there is provided a method of manufacturing a ceramic electronic component, including: preparing a ceramic body including a plurality of internal electrodes; forming a first external electrode layer electrically connected to the internal electrodes on external surfaces of the ceramic body; forming a second external electrode layer including nickel (Ni) on the first external electrode layer; forming a metal coating layer by applying a solder paste including tin (Sn) to external surfaces of the first external electrode layer and the second external electrode layer; and forming a diffusion layer through a reaction between the first and second external electrode layers and the solder paste.

The forming of the second external electrode layer may include applying a paste including 4 to 20 wt % of nickel to the first external electrode layer.

The forming of the metal coating layer may include dipping the first external electrode layer and the second external electrode layer in the solder paste for 60 seconds or less.

According to another aspect of the present invention, there is provided a method of manufacturing a ceramic electronic component, including: preparing a ceramic body including a plurality of internal electrodes; forming external electrode layers including nickel (Ni) and electrically connected to the internal electrodes on external surfaces of the ceramic body; forming metal coating layers by applying a solder paste including tin (Sn) to external surfaces of the external electrode layers; and forming diffusion layers through a reaction between the external electrode layers and the solder paste.

The forming of the external electrode layers may include applying a paste including 4 to 20 wt % of nickel to external surfaces of the ceramic body.

The forming of the metal coating layers may include dipping the external electrode layers in the solder paste for 60 seconds or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating an electronic component according to an embodiment of the present invention;

FIG. 2 is a cross-sectional view taken along line A-A′ of FIG. 1;

FIG. 3 is a flow chart schematically illustrating a method of manufacturing an electronic component according to an embodiment of the present invention;

FIG. 4A to 4D are cross-sectional views for describing a method of manufacturing an electronic component of FIG. 3;

FIG. 5 is a diagram illustrating a thickness of a diffusion layer over time in a melting solder method;

FIG. 6 is a cross-sectional view schematically illustrating an electronic component according to another embodiment of the present invention;

FIG. 7 is a flowchart schematically illustrating a method of manufacturing an electronic component according to another embodiment of the present invention; and

FIG. 8A to 8E are cross-sectional views for describing the method of manufacturing an electronic component of FIG. 7.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

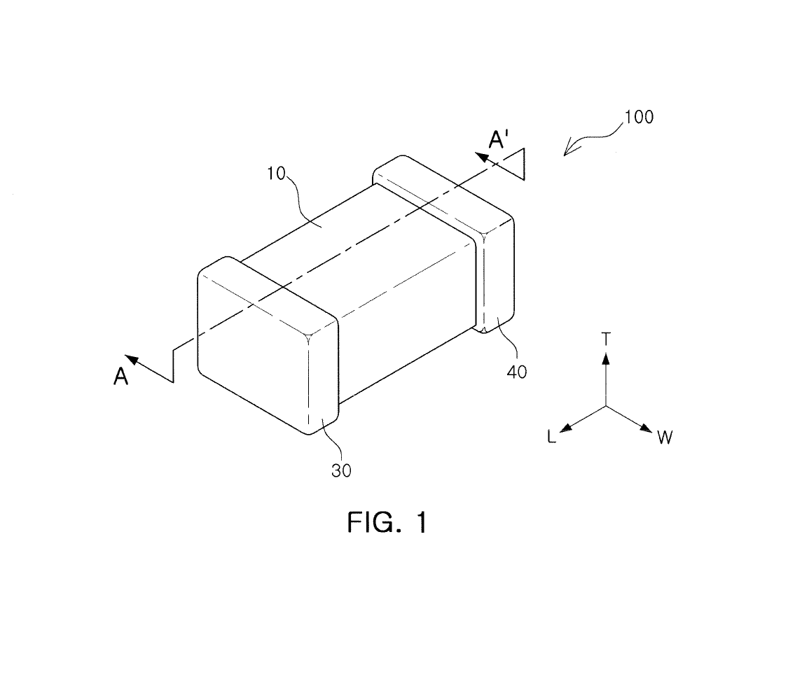

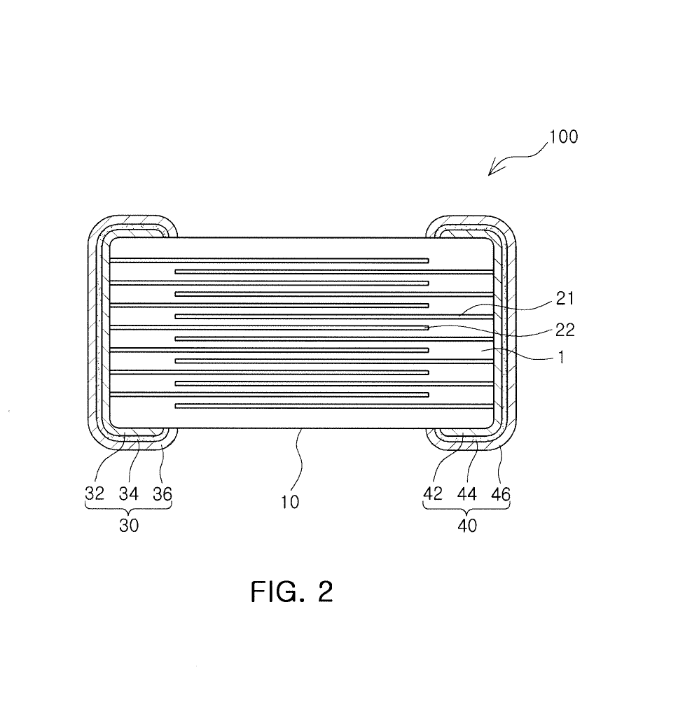

FIG. 1 is a perspective view schematically illustrating a ceramic electronic component according to an embodiment of the present invention and FIG. 2 is a cross-sectional view taken along line A-A′ of FIG. 1.

Referring to FIGS. 1 and 2, an electronic component 100 according to an embodiment of the present invention is a multi-layered ceramic capacitor that includes a ceramic element 10, internal electrodes 21 and 22, and external electrodes 30 and 40.

The ceramic element 10 is manufactured by stacking and sintering a plurality of dielectric layers 1, wherein the dielectric layers 1 may be integrated such that a boundary between adjacent dielectric layers 1 may not be readily apparent. The ceramic dielectric layer 1 may be formed of ceramic materials having a high dielectric constant, but the present invention is not limited thereto. That is, the dielectric layer 1 may also be formed of barium titanate (BaTiO₃)-based materials, lead complex perovskite-based materials, strontium titanate (SrTiO₃)-based materials, and the like.

The internal electrodes 21 and 22 are formed in the ceramic element 10 and external electrodes 30 and 40 are formed on external surfaces thereof.

The internal electrodes 21 and 22 may be disposed between the dielectric layers during a stacking process of the plurality of dielectric layers 1.

The internal electrodes 21 and 22 are a pair of electrodes having different polarities, alternately disposed to face each other in a stacking direction of the dielectric layers 1 with the dielectric layer 1 interposed therebetween so as to be electrically insulated from each other.

Ends of the internal electrode 2 are alternately exposed to both ends of the ceramic element 10. In this case, ends of the internal electrodes 21 and 22 exposed to respective ends of the ceramic element 10 are electrically connected to the external electrodes 30 and 40 to be described below.

The internal electrodes 21 and 22 may be formed of a conductive metal. In this case, the conductive metal is not particularly limited. For example, silver (Ag), lead (Pb), platinum (Pt), nickel (Ni), copper (Cu), or the like, may be used and one or a mixture of at least two thereof may be used.

In this case, the external electrodes 30 and 40 are electrically connected to the ends of the internal electrodes 21 and 22 exposed to respective ends of the ceramic element 10. Therefore, the external electrodes 30 and 40 may each be formed on both ends of the ceramic element 10.

The external electrodes 30 and 40 according to the embodiment of the present invention may include external electrode layers 32 and 42, diffusion layers 34 and 44, and metal coating layers 36 and 46.

The external electrode layers 32 and 42 may be formed of copper (Cu). In addition, the external electrode layers 32 and 42 may include nickel (Ni). Therefore, the external electrode layers 32 and 42 according to the embodiment of the present invention may be formed by applying and firing a conductive paste including a copper powder and a nickel powder to the external surfaces of the ceramic element 10. Here, a method of applying the conductive paste is not particularly limited. For example, various methods such as dipping, painting, printing, and the like, may be used.

The diffusion layers 34 and 44 are formed on external surfaces of the external electrode layers 32 and 42. The diffusion layers 34 and 44 according to the embodiment of the present invention may be formed by a reaction between the pastes forming the external electrode layers 32 and 42 and the metal coating layers 36 and 46.

The diffusion layers 34 and 44 may include a copper (Cu)—tin (Sn) alloy. Generally, a molten solder paste formed by the melting of tin (Sn) is in a high-temperature state and therefore, when the external electrode layers 32 and 42 formed of copper (Cu) are dipped, an intermetallic compound (IMC) layer such as Cu₆Sn₅ is formed between the external electrode layers 32 and 42 and the metal coating layers 36 and 46.

For convenience of explanation in the present specification, the intermetallic compound layer formed between the external electrode layers 32 and 42 and the metal coating layers 36 and 46 is here defined as being the diffusion layers 34 and 44.

Meanwhile, according to the embodiment of the present invention, the diffusion layers 34 and 44 may include nickel (Ni).

The metal coating layers 36 and 46 are formed on external surfaces of the diffusion layers 34 and 44. The metal coating layers 36 and 46 are provided to easily bond the ceramic electronic component 100 according to the embodiment of the present invention to electrodes formed on a substrate (not shown). Therefore, the metal coating layers 36 and 46 may be formed of a material that may be easily bonded to the electrode on the substrate, during the bonding process using soldering, solder, and the like.

In particular, the metal coating layers 36 and 46 according to the embodiment of the present invention may include at least one of a Sn—Ag—Cu alloy, a Sn—Ag—Cu—Ni alloy, and a Sn—Ag—Cu—Ni—Ge alloy. Specifically, the metal coating layers 36 and 46 may include additional materials based on a ternary composition of the Sn—Ag—Cu alloy.

Meanwhile, growth characteristics of the diffusion layers 34 and 44 may be changed based on a composition included in the metal coating layers 36 and 46.

As shown in FIG. 2, the external electrodes 30 and 40 may be formed to include the external electrode layers 32 and 42, the diffusion layers 34 and 44, and the metal coating layers 36 and 46, but the present invention is not limited thereto.

Hereinafter, a method of manufacturing an electronic component 100 according to the embodiment of the present invention will be described. The embodiment of the present invention describes, by way of example, a method of manufacturing a multi-layered ceramic capacitor as the electronic component 100, but the present invention is not limited thereto.

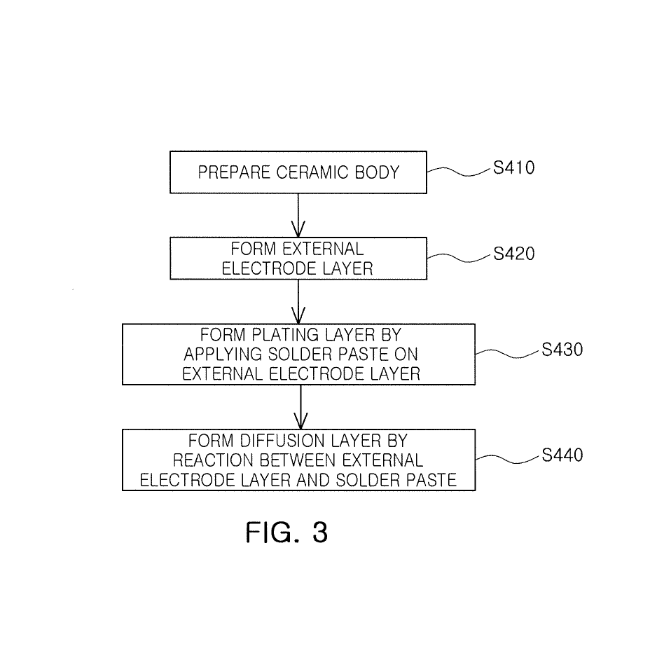

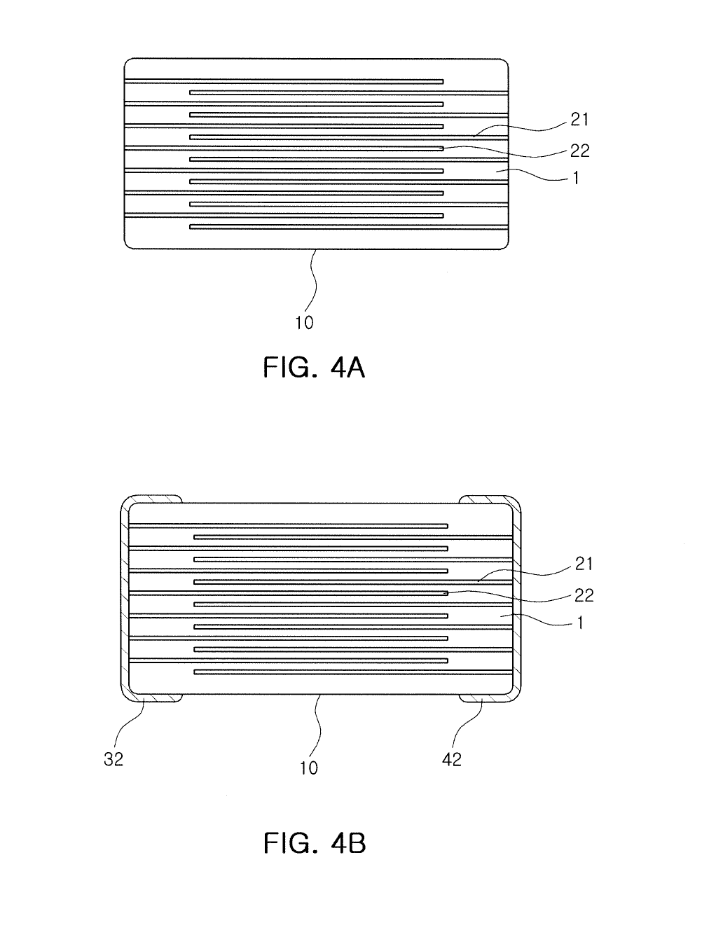

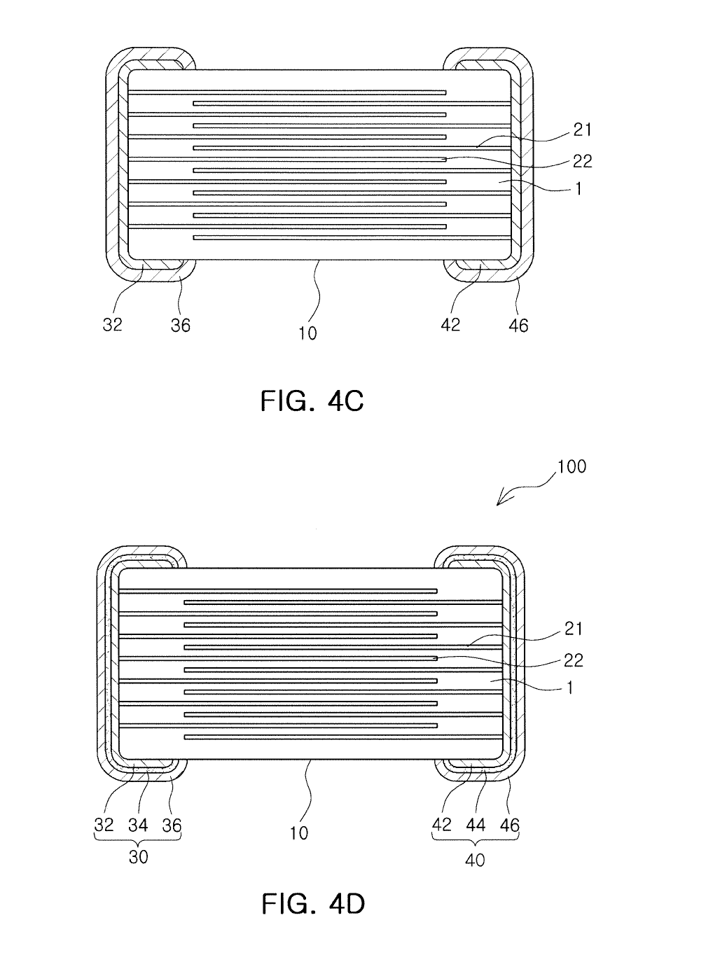

FIG. 3 is a flow chart schematically illustrating a method of manufacturing an electronic component according to an embodiment of the present invention and FIGS. 4A to 4D are cross-sectional views for describing a method of manufacturing an electronic component of FIG. 3.

Referring to FIGS. 3 and 4A to 4D, the method of manufacturing the electronic component 100 according to the embodiment of the present invention, that is, a multi-layered ceramic capacitor, may first include preparing the ceramic body 10 having a chip shape as shown in FIG. 4A (S410).

A shape of the ceramic body 10 may be a rectangular parallelepiped shape, but the present invention is not limited thereto.

The preparing of the ceramic body 10 having a chip shape is not particularly limited and therefore, may be carried out by a method of manufacturing a general ceramic laminate.

Described in more detail, a process of preparing a plurality of ceramic green sheets is first performed. Here, the ceramic green sheet may be fabricated by preparing a slurry by mixing a ceramic powder, a binder, and a solvent and forming the slurry as a sheet having a thickness of several μm by a Doctor blade method.

Next, internal electrode patterns are formed by applying the conductive paste forming the internal electrodes 21 and 22 to a surface of the ceramic green sheet. In this case, the internal electrode patterns may be formed by a screen printing method, but the present invention is not limited thereto.

The conductive paste may be manufactured in a paste form by dispersing a powder formed of nickel (Ni) or a nickel (Ni) alloy in an organic binder and an organic solvent.

Here, an organic binder commonly known in the art may be used, but the present invention is not limited thereto. For example, a binder formed of cellulose-based resin, epoxy resin, aryl resin, acrylic resin, phenol-formaldehyde resin, unsaturated polyester resin, polycarbonate resin, polyamide resin, polyimide resin, alkyd resin, rosin ester, and the like, may be used.

Further, the organic solvent commonly known in the art may be used, but the present invention is not limited thereto. For example, solvents, such as butyl carbitol, butyl carbitol acetate, turpentine oil, a-terpineol, ethyl cellosolve, butylphthalate, and the like, may be used.

Next, a process of compressing the multi-layered ceramic green sheets and the internal electrode patterns is performed by stacking and pressing the ceramic green sheets on which the internal electrode patterns are formed.

By this process, when the ceramic laminate in which the ceramic green sheets and the internal electrode patterns are alternately stacked is manufactured, the ceramic element 10 having a chip shape may be prepared by a process of cutting and firing the ceramic laminate.

Therefore, the ceramic element 10 may be formed to have a form in which the plurality of dielectric layers 1 and the internal electrodes 21 and 22 are alternately stacked.

Next, the method of manufacturing an electronic component according to the embodiment of the present invention may include forming the external electrode layers 32 and 42 on external surfaces of the ceramic element 10 as shown in FIG. 4B (S420).

The external electrode layers 32 and 42 may be formed of copper (Cu).

According to the embodiment of the present invention, the external electrode layers 32 and 42 may include nickel (Ni).

When the metal coating layers including tin (Sn) are formed on external surfaces of the external electrode layers 32 and 42, the diffusion layers may be formed. In this case, the nickel (Ni) included in the external electrode layers 32 and 42 may suppress the growth of the diffusion layers.

Here, the growth of the diffusion layers may be significantly reduced. Therefore, the growth of the diffusion layers may be significantly reduced by controlling a nickel (Ni) content included in the external electrode layers 32 and 42.

Meanwhile, a method of significantly reducing the growth of the diffusion layers due to the nickel (Ni) included in the external electrode layers 32 and 42 will be described below.

The external electrode layers 32 and 42 may be formed on the external surfaces of the ceramic element 10 by applying and firing the conductive paste prepared by adding glass frit to a copper (Cu) powder.

A method of applying the conductive paste is not particularly limited. For example, methods such as dipping, painting, printing, and the like, may be used.

Next, the method of manufacturing an electronic component according to the embodiment of the present invention may include forming the metal coating layers by applying the solder paste including tin (Sn) to the external surfaces of the external electrodes as shown in FIG. 4C (S430).

When the ceramic electronic component is mounted on the substrate, the metal coating layers 36 and 46 are formed on the external electrode layers 32 and 42 so as to facilitate the mounting thereof.

The solder paste may include at least one of a Sn—Ag—Cu alloy, a Sn—Ag—Cu—Ni alloy, and a Sn—Ag—Cu—Ni—Ge alloy.

Meanwhile, the solder paste is not limited thereto and may further include a composition that can be used for a general solder based on a ternary composition of Sn—Ag—Cu.

A method of forming the metal coating layers 36 and 46 on external surfaces of the external electrode layers 32 and 42 is not particularly limited. For example, the metal coating layers 36 and 46 may be formed by dipping the external electrode layers 32 and 42 in the solder paste including tin (Sn).

Specifically, the metal coating layers 36 and 46 may be formed by dipping the external electrode layers 32 and 42 in the solder paste including tin (Sn) for 1 to 60 seconds.

In detail, the method of forming the metal coating layers 36 and 46 may be performed by fixing the ceramic element 10 in which the external electrode layers 32 and 42 are formed to jigs and then by performing the dipping thereof in the solder paste.

When the electrical deposition method is used as the method of forming the metal coating layers 36 and 46 on external surfaces of the external electrode layers 32 and 42, the plating solution may be permeated into a portion in which the electrode layers are relatively thin, due to the thinness of the electrode layer.

The reliability of the multi-layered ceramic electronic component may be seriously affected due to the deterioration caused by the reaction between the plating solution and the internal electrodes due to the plating solution permeated into the electrode layer.

Further, in a case in which the electrical deposition method is applied in a state in which the plating solution is included in the external electrode layers or the plating solution surrounds a weak portion of the ceramic element, crack defects may also occur in the ceramic element due to a pressure by hydrogen generated at the time of the plating.

According to the embodiment of the present invention, the metal coating layers 36 and 46 may be formed by dipping the external electrode layers formed on the ceramic element in a solder paste including metal, instead of forming the metal coating layers 36 and 46 on external surfaces of the external electrode layers 32 and 42 by the electrical deposition method, thereby improving the foregoing defects.

In detail, according to the embodiment of the present invention, even in a case in which the thickness of the external electrode layers is relatively thin, the metal coating layers 36 and 46 are formed on external surfaces of the external electrode layers by the dipping, such that the metal may not be permeated into the internal electrodes.

In addition, since the electrical deposition method is not used, the deterioration by the reaction between the melting metal and the internal electrodes may not also occur.

In addition, according to the embodiment of the present invention, the hydrogen gas enough to cause the occurrence of cracks of the ceramic element 10 is not generated and thus, the reliability of the multi-layered ceramic element may be greatly improved.

Next, the method of manufacturing an electronic component according to the embodiment of the present invention may include forming the diffusion layers by the reaction between the external electrode layers and the metal coating layers as shown in FIG. 4D (S440).

The forming of the diffusion layers 34 and 44 may be performed during the dipping of the external electrode layers 32 and 42 of the electronic component in the solder paste including tin (Sn). That is, the diffusion layers 34 and 44 may be generated during the process of forming the metal coating layers 36 and 46 on external surfaces of the external electrode layers 32 and 42 by a high-temperature melting solder dipping method.

The diffusion layers 34 and 44 may include a copper (Cu)—tin (Sn) alloy. Generally, the molten solder formed by the melting of tin (Sn) is in a relatively high-temperature state and therefore, when the external electrode layers 32 and 42 formed of copper (Cu) are dipped therein, the diffusion layers such as Cu₆Sn₅ are formed between the external electrode layers 32 and 42 and the metal coating layers 36 and 46.

In this case, in order to suppress the growth of the diffusion layer, nickel (Ni) may be used. The reason is that nickel (Ni) is generally known as suppressing the growth of the diffusion layer.

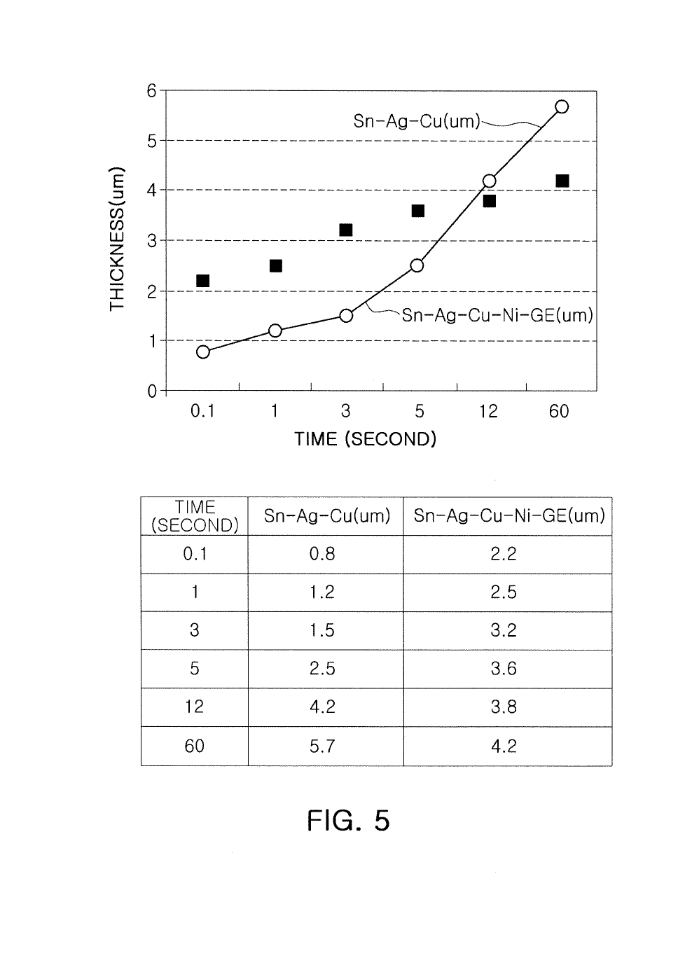

FIG. 5 is a diagram illustrating the thickness of the diffusion layers over time in a melting solder method.

Referring to FIG. 5, when Sn—Ag—Cu composition or Sn—Ag—Cu—Ni—Ge composition is included in the solder paste, the thickness of the diffusion layers over time may be compared.

As shown in FIG. 5, the solder paste including the Sn—Ag—Cu—Ni—based composition may effectively suppress the growth of the diffusion layers due to nickel (Ni). However, the solder paste including the Sn—Ag—Cu—Ni—based composition initially forms the diffusion layers thickly.

The solder paste including the Sn—Ag—Cu—based composition may initially form the diffusion layers thinly. However, the solder paste including the Sn—Ag—Cu—based composition does not include nickel (Ni), such that the growth of the diffusion layers cannot be suppressed. Therefore, the thickness of the diffusion layers is suddenly increased after a predetermined time lapses.

Specifically, the thickness of the diffusion layer may be required to be significantly reduced. More specifically, the diffusion layers may have a thickness only enough to block the penetration of moisture and tin (Sn).

Therefore, the Sn—Ag—Cu—based solder paste maybe used to form the metal coating layer as long as the sudden growth of the diffusion layers after a predetermined time lapses can be only controlled. The reason is that the Sn—Ag—Cu—based solder paste may allow for the thickness of an initial diffusion layer to be relatively thin.

Meanwhile, according to the embodiment of the present invention, the external electrode layers 32 and 42 may include nickel (Ni).

Therefore, when the metal coating layers 36 and 46 are formed on the external electrode layers 32 and 42 including nickel (Ni) by using the Sn—Ag—Cu—based solder paste, the nickel (Ni) included in the external electrode layers 32 and 42 may move to a point including the tin (Sn) component due to a reaction mechanism with the solder paste including tin (Sn).

That is, when the external electrode layers 32 and 42 are dipped in the melting solder, the tin (Sn) of the melting solder reacts with the copper (Cu) of the external electrode layers 32 and 42 to form the copper (Cu)—tin (Sn) diffusion layers 34 and 44 having a thin film form on external surfaces of the external electrode layers 32 and 42. Further, the nickel (Ni) included in the external electrode layers is uniformly dispersed in the copper (Cu)—tin (Sn) diffusion layers 34 and 44 after the predetermined time lapses during the process.

As such, as nickel (Ni) is disposed in the copper (Cu)—tin (Sn) diffusion layers 34 and 44 after the predetermined time lapses, the excessive growth of the copper (Cu)—tin (Sn) diffusion layers 34 and 44 is suppressed as described above.

Therefore, the case in which the external electrode layers 32 and 42 include nickel (Ni) may exhibit the same effect as suppressing the growth of the diffusion layers including the solder paste having the Sn—Ag—Cu—Ni—based composition, even in the case that the solder paste forming the metal coating layers 36 and 46 does not include nickel (Ni).

That is, the thickness of the diffusion layers including the solder paste having the Sn—Ag—Cu—based composition may be initially formed relatively thinly, and then, the increase rate of thickness of the diffusion layers may be slowed due to the action of nickel (Ni) included in the external electrode layers 32 and 42 after the predetermined time lapses.

However, in a case in which the nickel (Ni) content included in the external electrode layers is relatively too small or too large, there may be defects in that the metal coating layers are not formed or a nickel (Ni) alloy layer to be included in the diffusion layers is not formed.

Therefore, it is essential to appropriately control the nickel (Ni) content included in the electrode layer.

Table 1 shows whether the nickel (Ni) alloy layers included in the diffusion layers are generated, whether the metal coating layers are generated, and the reliability of the ceramic electronic component is provided, according to the nickel (Ni) content within the external electrode layers.

TABLE 1

| Content of Ni in | Whether Ni | Whether metal | |
|---|---|---|---|
| Electrode Paste | alloy layer | coating layer | |
| (wt %) | is generated | is generated | Reliability |
| 3 | X | ◯ | X |
| 5 | ◯ | ◯ | ◯ |
| 10 | ◯ | ◯ | ◯ |
| 20 | ◯ | ◯ | ◯ |
| 30 | ◯ | X | X |
| 40 | ◯ | X | X |
| 50 | ◯ | x | X |

Referring to Table 1, when the content of nickel within the electrode paste is 3 wt %, the nickel alloy layer is not generated within the diffusion layer. The reason is that the alloy layer generation reaction may occur only when the nickel content is equal to a predetermined numerical value or more.

In addition, the nickel content within the electrode paste is 30 (wt %), the metal coating layers are not generated. That is, when the nickel content within the electrode paste is 30 wt % or more, the metal coating layers cannot be generated.

As can be confirmed from Table 1, only when 4 to 20 wt % of nickel (Ni) is included in the electrode paste, the nickel alloy layer may be generated within the diffusion layers and the metal coating layers may be normally generated.

Therefore, when the electrode paste includes 4 to 20 wt % of nickel, the ceramic electronic component with the reliability may be manufactured.

The method of manufacturing an electronic component according to the embodiment of the present invention configured as described above does not depend on the process of the related art using the plating solution during the process of forming the external electrodes, and uses the method of forming the metal coating layers by dipping the external electrode layers in the melting solder.

When the plating solution is permeated into the external electrodes, the reliability of the electronic component may be seriously affected due to the deterioration caused by the reaction between the plating solution and the internal electrodes. Further, when the electrical deposition method is performed in the state in which the plating solution is included in the external electrodes or the plating solution is introduced into the ceramic element, the ceramic element may be damaged due to the pressure by hydrogen gas generated during the plating process.

However, the method of manufacturing an electronic component according to the embodiment of the present invention does not include the plating process using the plating solution and therefore, the electronic component may not be damaged due to the permeation of the plating solution into the electronic component or due to the hydrogen gas generated at the time of the plating. Therefore, the reliability of the electronic component may be largely improved.

In addition, the method of manufacturing an electronic component according to the embodiment of the present invention includes forming the diffusion layers using a Cu electrode layer including the solder paste of the Sn—Ag—Cu composition and Ni and therefore, the thickness of the diffusion layers may be significantly reduced due to the action of nickel (Ni).

Therefore, the performance of the electronic component may be prevented from being degraded due to the excessive growth of the diffusion layers.

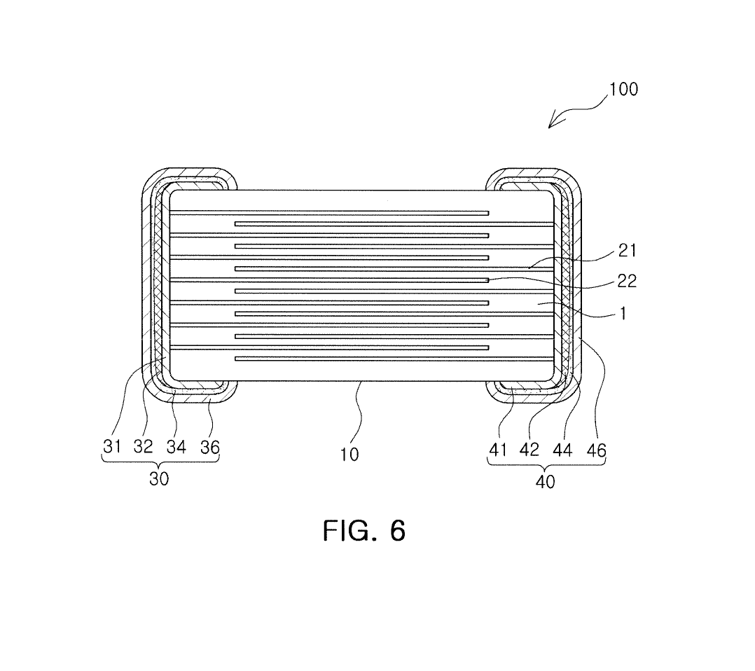

FIG. 6 is a cross-sectional view schematically illustrating a ceramic electronic component according to another embodiment of the present invention.

The ceramic electronic component may include a first external electrode layer 41 and a second external electrode layer 42.

The first external electrode layer 41 may be formed of a general electrode paste material that does not include nickel (Ni).

The second external electrode layer 42 may be formed on the first external electrode layer 41. The second external electrode layer 42 may have no or a little bit of glass-based component. In addition, the second external electrode layer 42 may include nickel (Ni).

As described above, the nickel (Ni) may suppress the growth of the diffusion layers formed later.

The foregoing contents may be similarly applied except that the external electrode layers are configured to include the first external electrode layer 41 that does not include nickel (Ni) and the second external electrode layer 42 including the nickel (Ni) formed on the first external electrode layer 41 and therefore, the description of portions overlapping with the foregoing description will be omitted.

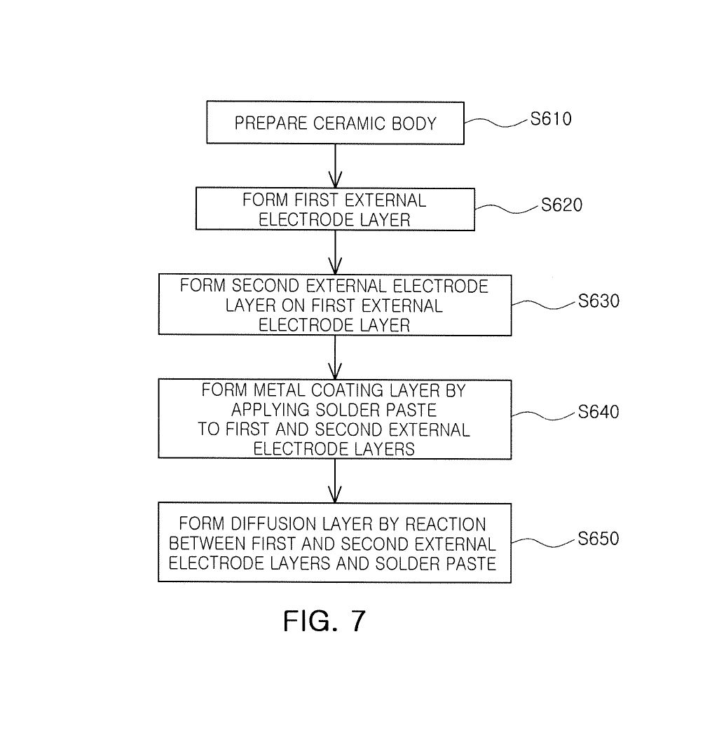

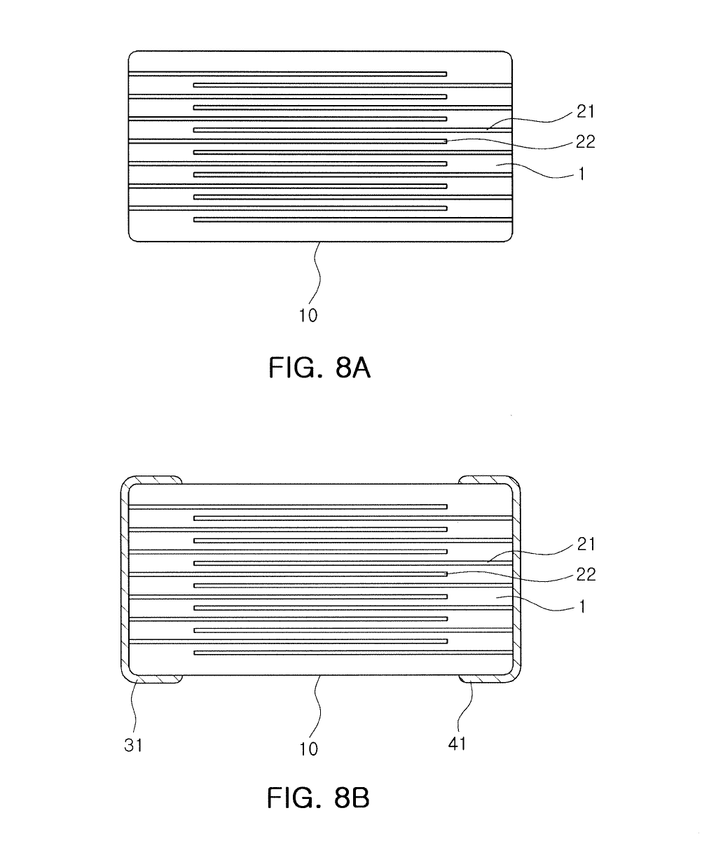

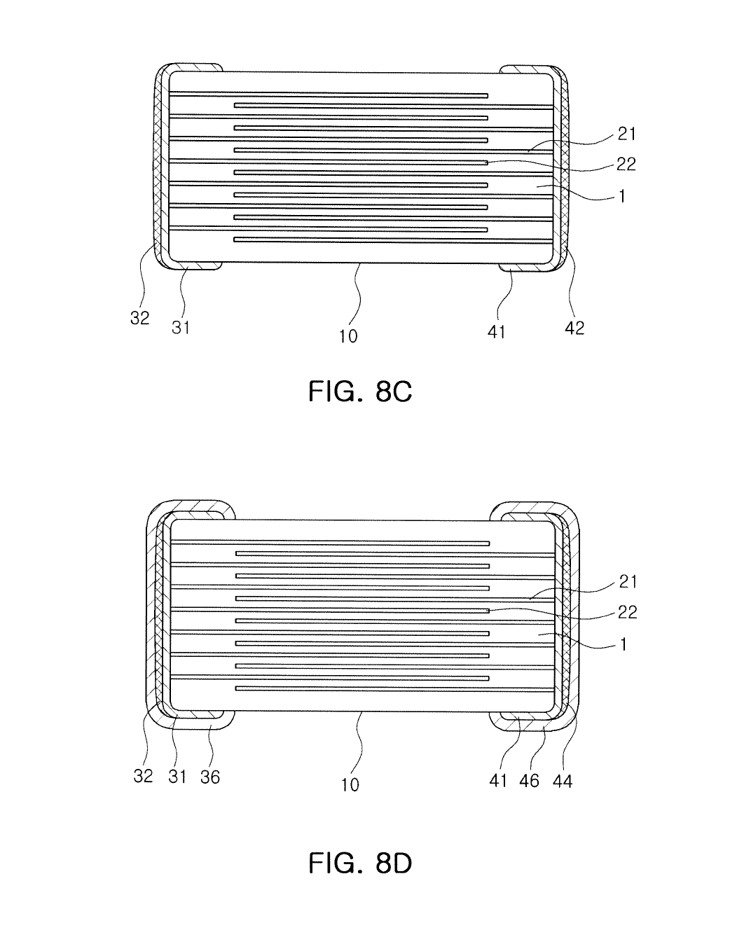

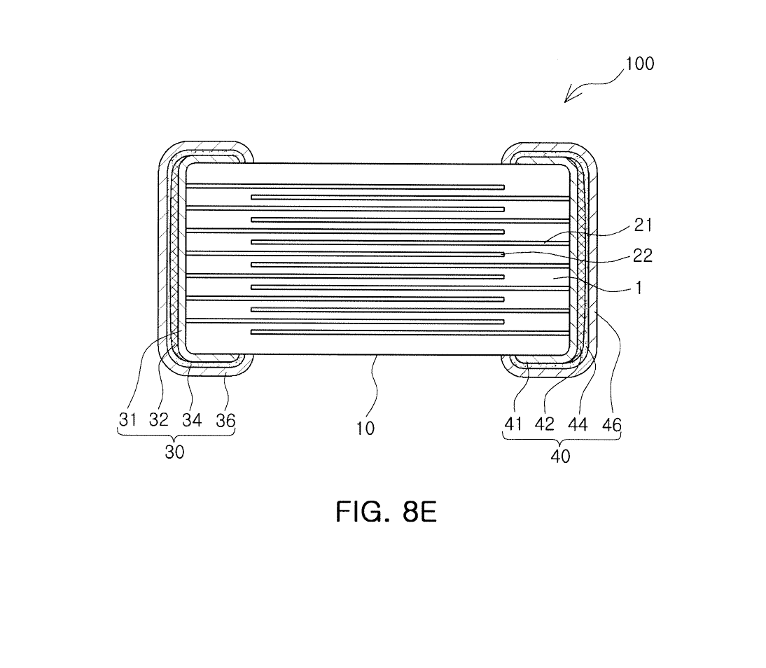

FIG. 7 is a flow chart schematically illustrating a method of manufacturing an electronic component according to another embodiment of the present invention and FIGS. 8A to 8E are cross-sectional views for describing the method of manufacturing an electronic component of FIG. 7.

Referring to FIGS. 7 and 8A to 8E, the method of manufacturing an electronic component according to another embodiment of the present invention may include preparing the ceramic body 10 having a chip shape (S610, FIG. 8A), forming the first external electrode layers 31 and 41 on external surfaces of the ceramic body 10 (S620, FIG. 8B), forming the second external electrode layers 32 and 42 including the nickel (Ni) on the first external electrode layers 31 and 41 (S630, FIG. 8C), forming the metal coating layers by applying the solder paste to the external surfaces of the first external electrode layer and the second external electrode layer (S640, FIG. 8D), and forming the diffusion layers by the reaction between the first external electrode layer and the second external electrode layer and the solder paste (S650, FIG. 8E).

The method of manufacturing a ceramic electronic component may include forming the first external electrode layers 31 and 41 on external surfaces of the ceramic body 10 (S620, FIG. 8B).

The first external electrode layers 31 and 41 may be formed of a general electrode paste material that does not include nickel (Ni).

In addition, the method of manufacturing a ceramic electronic component may include forming the second external electrode layers 32 and 42 including nickel (Ni) on the first external electrode layers 31 and 41 (S630, FIG. 8C).

The second external electrode layers 32 and 42 have no or a little bit of glass-based component and may be formed of a paste material including nickel (Ni).

As described above, the nickel (Ni) may suppress the growth of the diffusion layers formed later.

In the method of manufacturing a ceramic electronic component according to another embodiment of the present invention, the description of the portions overlapping with the description of the method of manufacturing a ceramic electronic component according to the embodiment of the present invention as described above will be omitted.

Meanwhile, the electronic component and the method of manufacturing an electronic component are not limited to the foregoing embodiments and can be variously modified by those skilled in the art within the technical spirit of the present invention.

Although the foregoing embodiments describe the multi-layered ceramic capacitor and the method of manufacturing the same by way of example, the present invention is not limited thereto and may be widely applied to the electronic component in which the external electrode layers are formed on external surfaces thereof and the metal coating layers are formed on the external electrode layers.

In detail, as set forth above, according to the embodiment of the present invention, the method of manufacturing a ceramic electronic component, in which the metal coating layer is formed by applying the solder paste thereto, may be provided.

Further, as set forth above, a ceramic electronic component capable of significantly reducing an IMC layer formed between the electrode layer and the metal coating layer may be formed according to the embodiment of the present invention.

In addition, as set forth above, a ceramic electronic component capable of diversifying the composition of the solder paste and the method of manufacturing the same may be provided.

While the present invention has been shown and described in connection with the embodiments, it will be apparent to those skilled in the art that modifications and variations can be made without departing from the spirit and scope of the invention as defined by the appended claims.

What is claimed is:

1. A ceramic electronic component, comprising:
a ceramic body including a plurality of internal electrodes;
a first external electrode layer electrically connected to the internal electrodes and formed on external surfaces of the ceramic body;
a second external electrode layer including nickel (Ni), formed on the first external electrode layer;
a metal coating layer including tin (Sn), formed on external surfaces of the first external electrode layer and the second external electrode layer; and
a diffusion layer formed between the first and second external electrode layers and the metal coating layer.

2. The ceramic electronic component of claim 1, wherein the first external electrode layer and the second external electrode layer include copper (Cu).

3. The ceramic electronic component of claim 1, wherein the metal coating layer includes at least one of a Sn—Ag—Cu alloy, a Sn—Ag—Cu—Ni alloy, and a Sn—Ag—Cu—Ni—Ge alloy.

4. The ceramic electronic component of claim 1, wherein the diffusion layer includes a copper (Cu)—tin (Sn) alloy.

5. A ceramic electronic component, comprising:
a ceramic body including a plurality of internal electrodes;
external electrode layers electrically connected to the internal electrodes, including nickel (Ni), and formed on external surfaces of the ceramic body;
a metal coating layer including tin (Sn), formed on external surfaces of the external electrode layers; and
a diffusion layer formed between the external electrode layer and the metal coating layer.

6. The ceramic electronic component of claim 5, wherein the metal coating layer includes at least one of a Sn—Ag—Cu alloy, a Sn—Ag—Cu—Ni alloy, and a Sn—Ag—Cu—Ni—Ge alloy.

7. The ceramic electronic component of claim 5, wherein the diffusion layer includes a copper (Cu)—tin (Sn) alloy.

8. A method of manufacturing a ceramic electronic component, comprising:
preparing a ceramic body including a plurality of internal electrodes;
forming a first external electrode layer electrically connected to the internal electrode on external surfaces of the ceramic body;
forming a second external electrode layer including nickel (Ni) on the first external electrode layer;
forming a metal coating layer by applying a solder paste including tin (Sn) to external surfaces of the first external electrode layer and the second external electrode layer; and
forming a diffusion layer through a reaction between the first and second external electrode layers and the solder paste.

9. The method of claim 8, wherein the forming of the second external electrode layer includes applying a paste including 4 to 20 wt % of nickel to the first external electrode layer.

10. The method of claim 8, wherein the forming of the metal coating layer includes dipping the first external electrode layer and the second external electrode layer in the solder paste for 60 seconds or less.

11. A method of manufacturing a ceramic electronic component, comprising:
preparing a ceramic body including a plurality of internal electrodes;
forming external electrode layers including nickel (Ni) and electrically connected to the internal electrodes on external surfaces of the ceramic body;
forming metal coating layers by applying a solder paste including tin (Sn) to external surfaces of the external electrode layers; and
forming diffusion layers through a reaction between the external electrode layers and the solder paste.

12. The method of claim 11, wherein the forming of the external electrode layers includes applying a paste including 4 to 20 wt % of nickel to external surfaces of the ceramic body.

13. The method of claim 11, wherein the forming of the metal coating layers includes dipping the external electrode layers in the solder paste for 60 seconds or less.
